(19) United States
(12) Patent Application Publication
(10) Pub. No.: US 2016/0026373 A1
(43) Pub. Date: Jan. 28, 2016

(54) ACTIONABLE STEPS WITHIN A PROCESS FLOW

(71) Applicant: Microsoft Corporation, Redmond, WA (US)

(72) Inventors: Karan Srivastava, Bellevue, WA (US); Palak Kadakia, Redmond, WA (US); Shashi Ranjan, Remond, WA (US); Nirav Shah, Bothell, WA (US)

(21) Appl. No.: 14/340,536

(22) Filed: Jul. 24, 2014

(51) Int. Cl. G06F 3/0484

(52) U.S. Cl. CPC G06F 3/04847; G06F 3/04842

(57) ABSTRACT

A computer system displays various stages corresponding to a process. As a user enters a stage in the process, the computer system displays a plurality of different steps corresponding to the given stage. Each step can have a user input mechanism that is mapped to corresponding action functionality. When the user input mechanism is actuated, the action for the corresponding action functionality is performed within the computer system.

### BACKGROUND

Computer systems are currently in wide use. Some such computer systems execute processes according to a designed process flow.

For instance, some computer systems include business systems, such as enterprise resource planning (ERP) systems, customer relations management (CRM) systems, line-of-business (LOB) systems, etc. These types of computer systems can run business processes that are defined using metadata. The business processes can be launched and run on business data records and other business information, thus allowing a user to perform activities or other steps in order to do their job for the business or organization that is using the business system.

Such business systems often use forms as a mechanism by which to display information to a user who is using the business system. The displayed information can be information regarding a business process or an entity or another business record. Entities can be data records that represent an underlying item within the business system. For instance, a customer entity is a business record that describes and represents a customer. A vendor entity includes information that describes and represents a vendor. Product entities describe and represent products. Inventory entities describe certain aspects of inventory. Business opportunity entities describe and represent business opportunities. Quote entities describe and represent quotes that are made to customers, etc. This is just a small set of examples of entities. Entities can be objects that have callable methods or items with even more rich functionality, as an example.

Business processes can access, and operate on, the entities or other data records in order to guide a user through a business process. Some business processes only provide functionality for capturing user inputs. Thus, if a user wishes to perform an action, the user often needs to navigate to another portion of the business system in order to perform that action. Some business processes can also include information from local or other systems and can have actions that manipulate data in local or external systems that are integrated with, or disconnected from, the business system.

The discussion above is merely provided for general background information and is not intended to be used as an aid in determining the scope of the claimed subject matter.

### SUMMARY

A computer system displays various stages corresponding to a process. As a user enters a stage in the process, the computer system displays a plurality of different steps corresponding to the given stage. Each step can have a user input mechanism that is mapped to corresponding action functionality. When the user input mechanism is actuated, the action for the corresponding action functionality is performed within the computer system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a business system architecture.

FIG. 2 is a block diagram showing one example of a business process configuration system in more detail.

FIGS. 3A-3B (collectively FIG. 3) illustrate a flow diagram that shows one example of the operation of a business process configuration system.

FIG. 4 is a flow diagram showing one example of the operation of the business process configuration system in more detail.

FIGS. 4A-4G show examples of user interface displays.

FIG. 5 is a flow diagram illustrating one example of runtime operation of the business system shown in FIG. 1.

FIGS. 5A-5C show examples of user interface displays.

FIG. 6 is a block diagram showing one example of the architecture shown in FIG. 1, deployed in a cloud computing architecture.

FIGS. 7-9 show examples of mobile devices.

FIG. 10 is a block diagram of one example of a computing environment.

### DETAILED DESCRIPTION

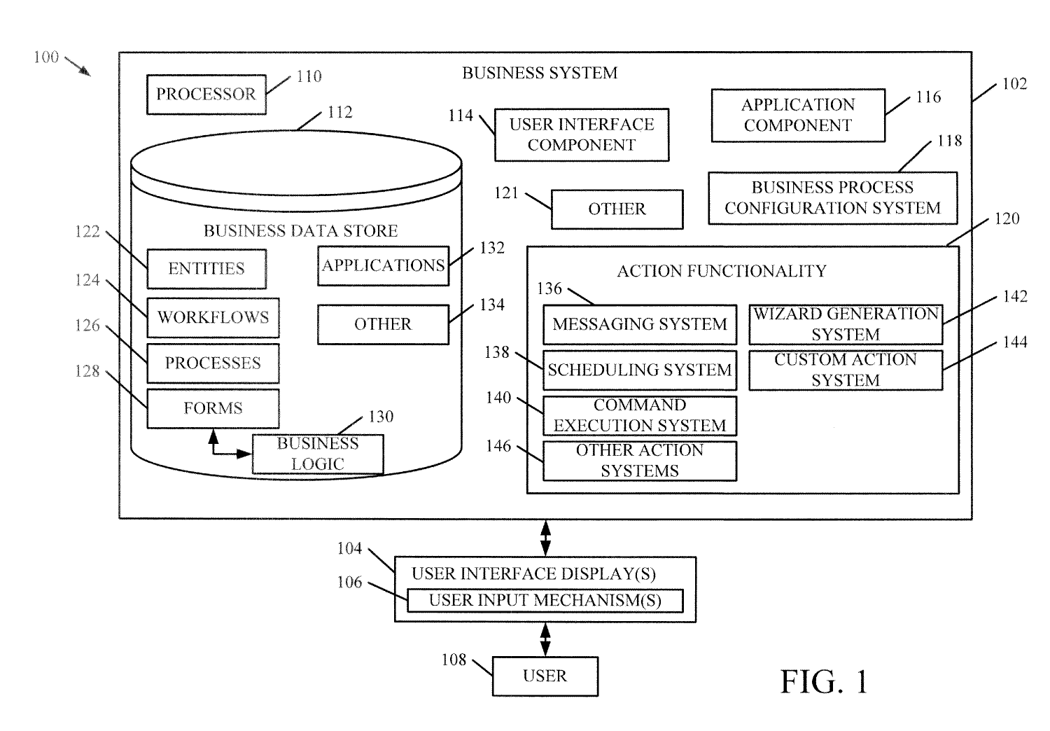

FIG. 1 is a block diagram of one example of a business system architecture 100. Architecture 100 illustratively includes business system 102 that generates user interface displays 104, with user input mechanisms 106, for interaction by user 108. User 108 can illustratively be an administrator or a developer that interacts with business system 102 to develop or configure business system 102. User 108 can also be an end user that interacts with user input mechanisms 106 to control and manipulate business system 102, during runtime.

In the example shown in FIG. 1, business system 102 illustratively includes processor 110, business data store 112, user interface component 114, application component 116, business process configuration system 118, and action functionality 120. It can include other items 121 as well.

Business data store 112 illustratively stores business data, such as entities 122, workflows 124, processes 126, forms 128 that may include business logic 130, applications 132 and other data records 134. Application component 116 illustratively runs applications 132, which perform processes 126 or workflows 124 and can operate on entities 122. The applications 132 can also display data using forms 128 and perform operations based on business logic 130 associated with the forms 128. Thus, in one example, application component 116 can be a general ledger application or other accounting applications. It can be an inventory tracking application, a customer service application, a business opportunity application that tracks business opportunities from lead to cash, or a wide variety of other applications. Each application can access and run a variety of different business processes.

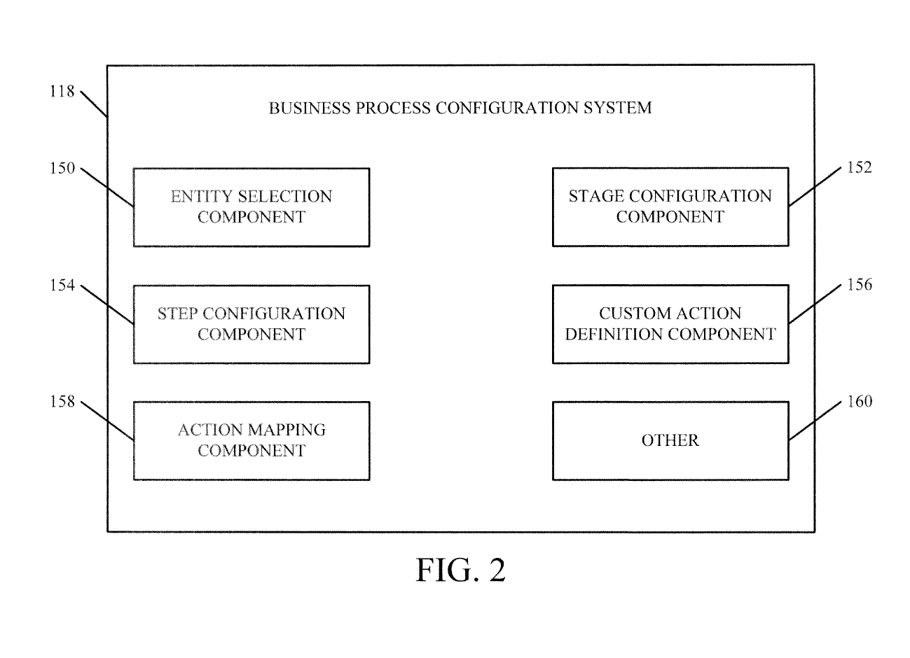

Business process configuration system 118 (which is described in greater detail below with respect to FIG. 2) illustratively generates user interface displays with user input mechanisms that allow a user to configure processes 126. For instance, system 118 illustratively allows the user to configure processes 126 to contain a sequence of stages. The user can also configure each stage to have one or more steps. In the example described herein, system 118 can illustratively map the steps to action functionality 120 so that a user, during runtime, can take actions directly from the user interface display that represents the process.

Action functionality 120 includes a variety of different types of functionality that enable a user to take actions within business system 102. For example, it can include messaging system 136 that allows user 108 to send and receive a variety of different types of messages, such as electronic mail messages, instant messaging messages, telephone messages, etc. Functionality 120 can also include scheduling system 138 that allows a user to schedule meetings, send meeting requests, schedule appointments or perform a variety of other tasks related to scheduling or calendaring operations. Functionality 120 can also include command execution system 140 that executes commands within business system 102. Some examples of commands are described in greater detail below. Wizard generation system 142 illustratively generates wizards for interaction by a user during runtime. Customer action system 144 illustratively includes a custom action generation system that allows a user to generate a customer action, and customer action functionality that allows a user to perform the customer action during runtime. Action functionality 120 can include other action systems 146, for performing other actions, as well.

FIG. 2 is a block diagram showing one example of business process configuration system 118 in more detail. In the example shown in FIG. 2, system 118 illustratively includes entity selection component 150, stage configuration component 152, step configuration component 154, custom action definition component 156, action mapping component 158, and it can include other items 160 as well.

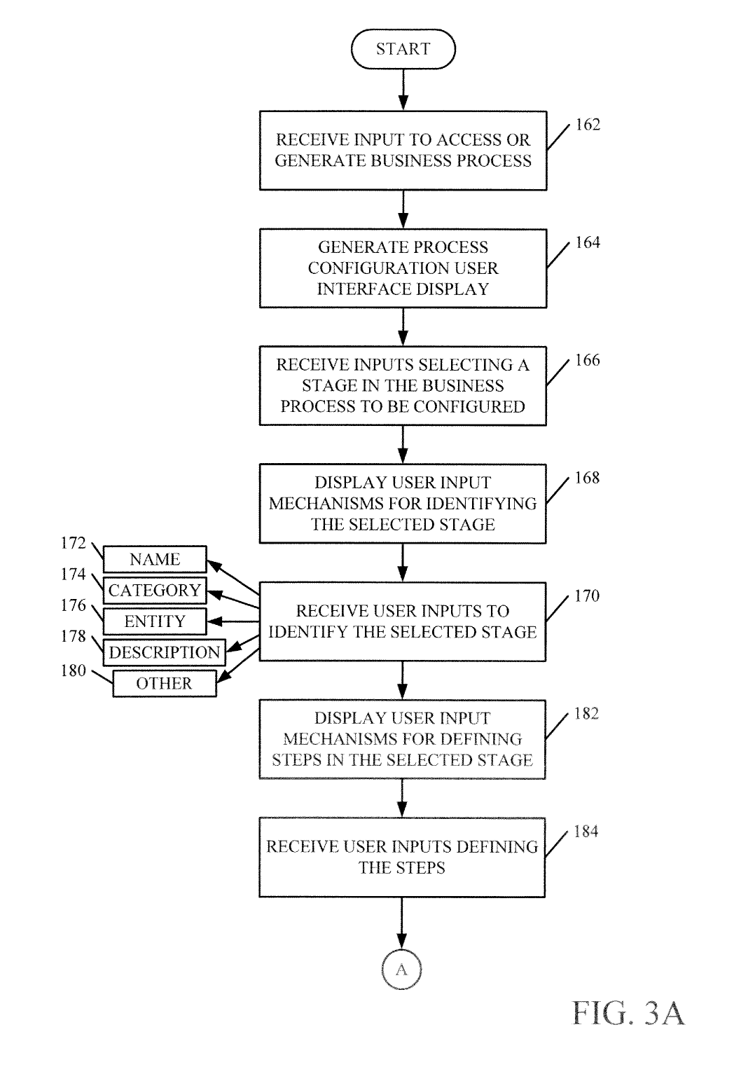

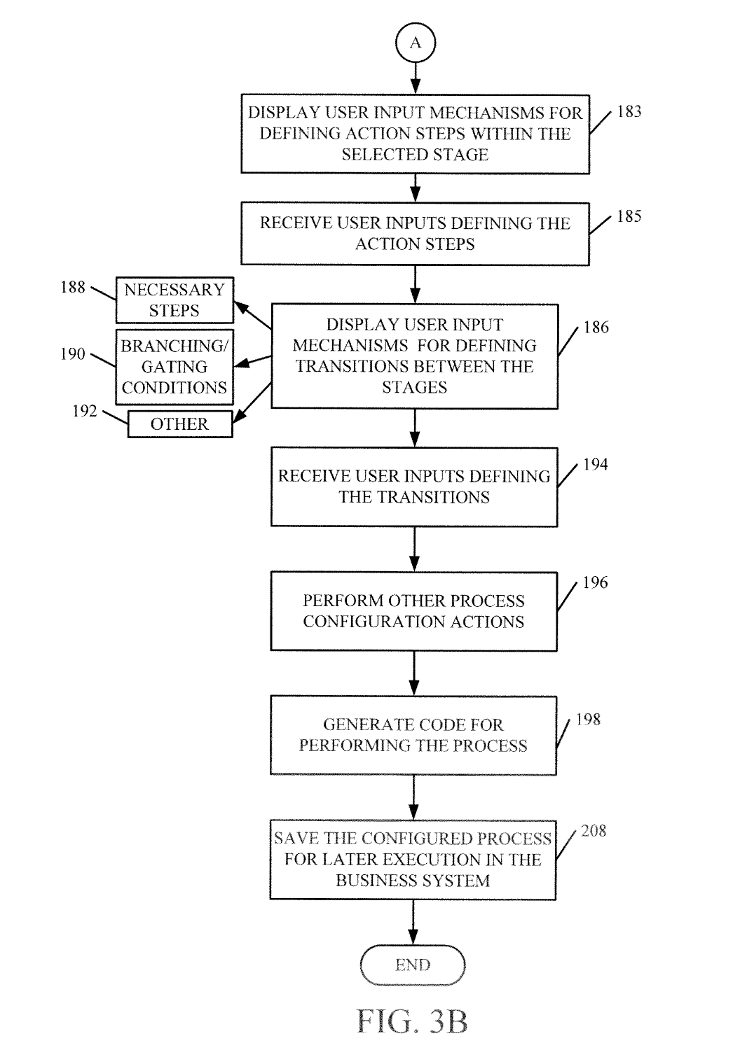

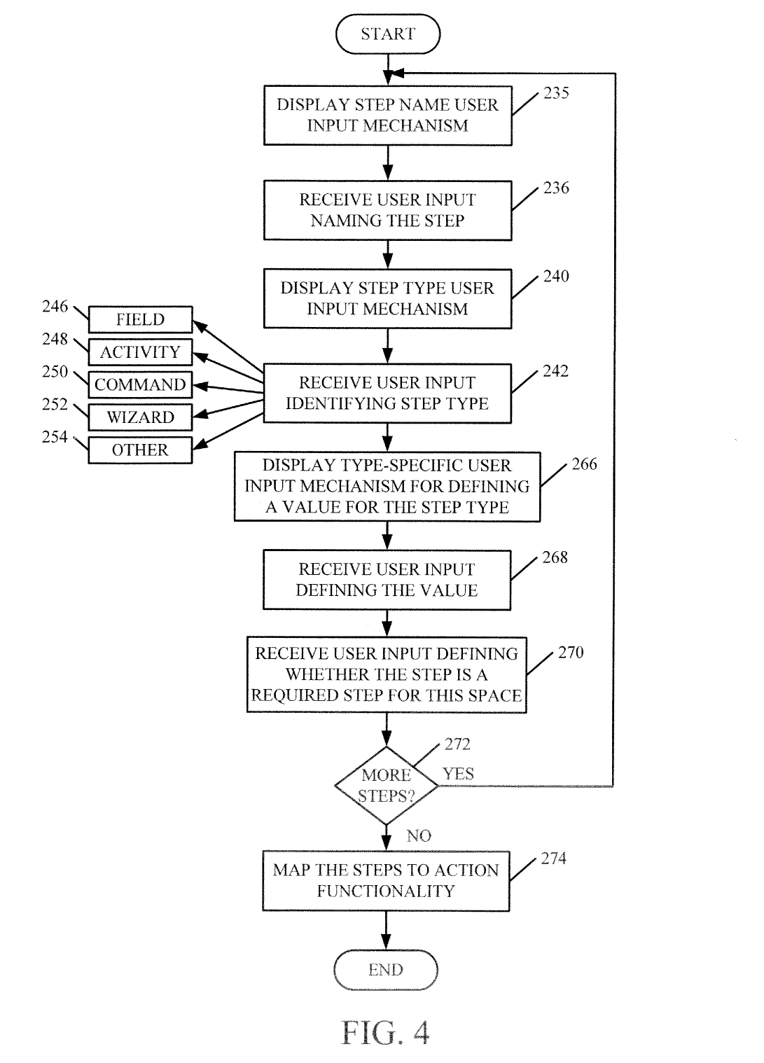

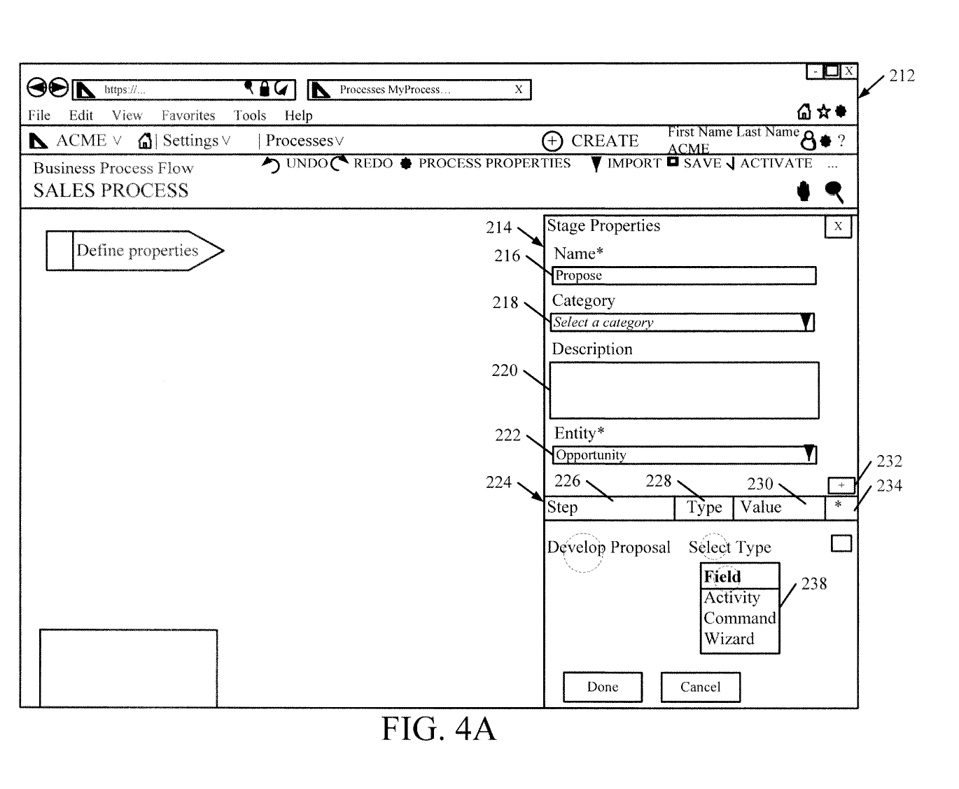

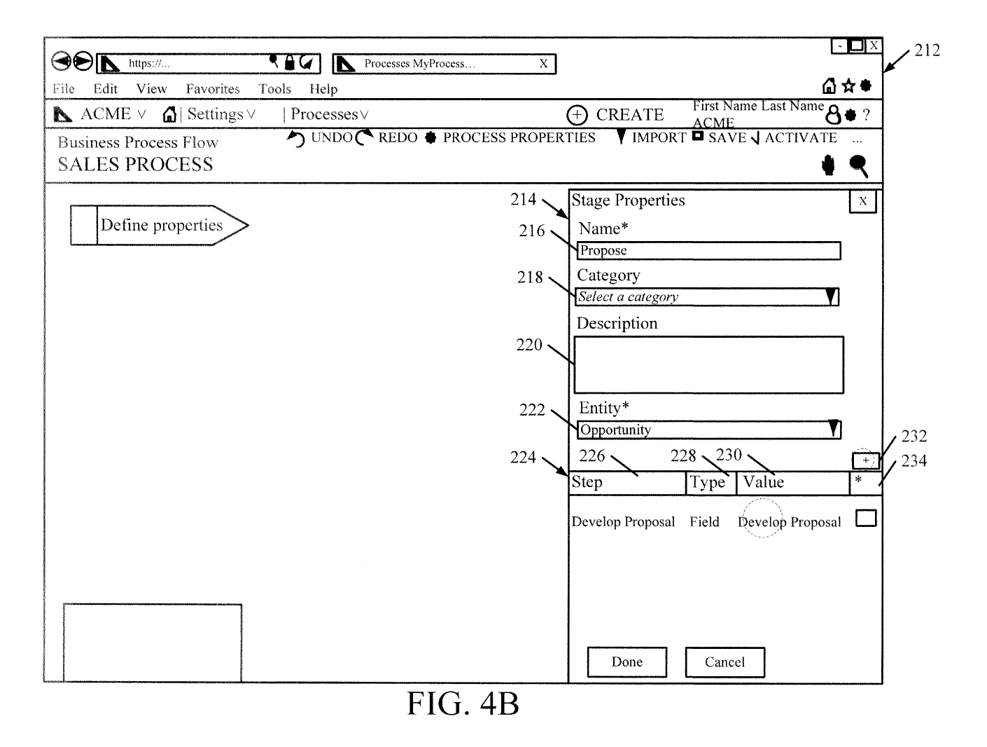

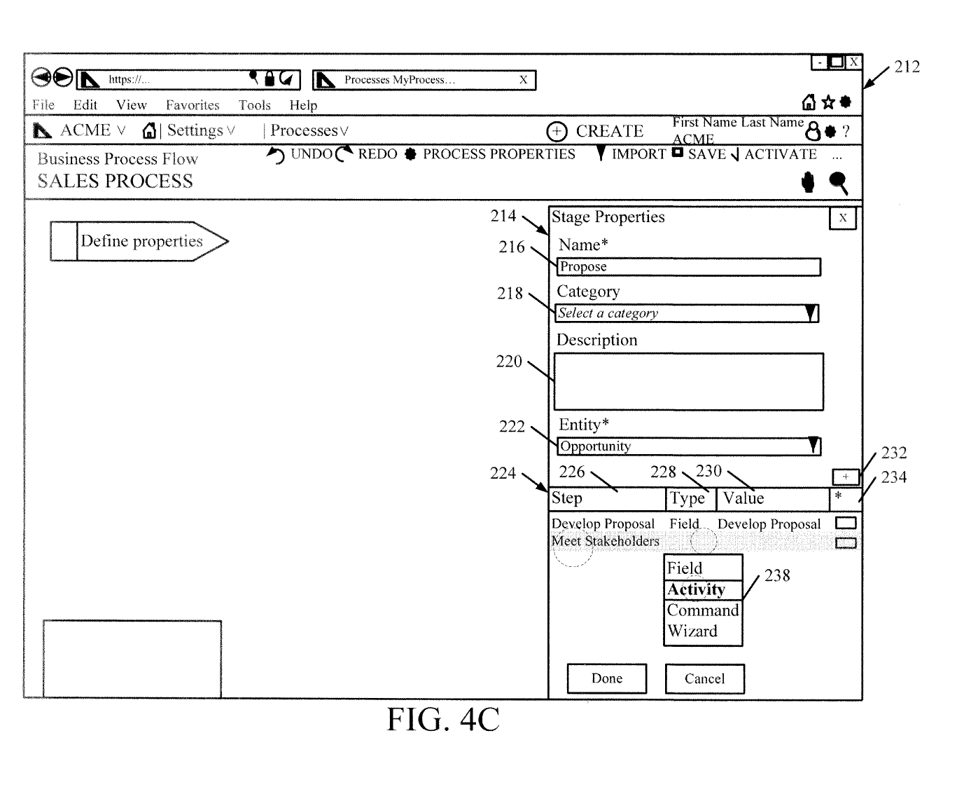

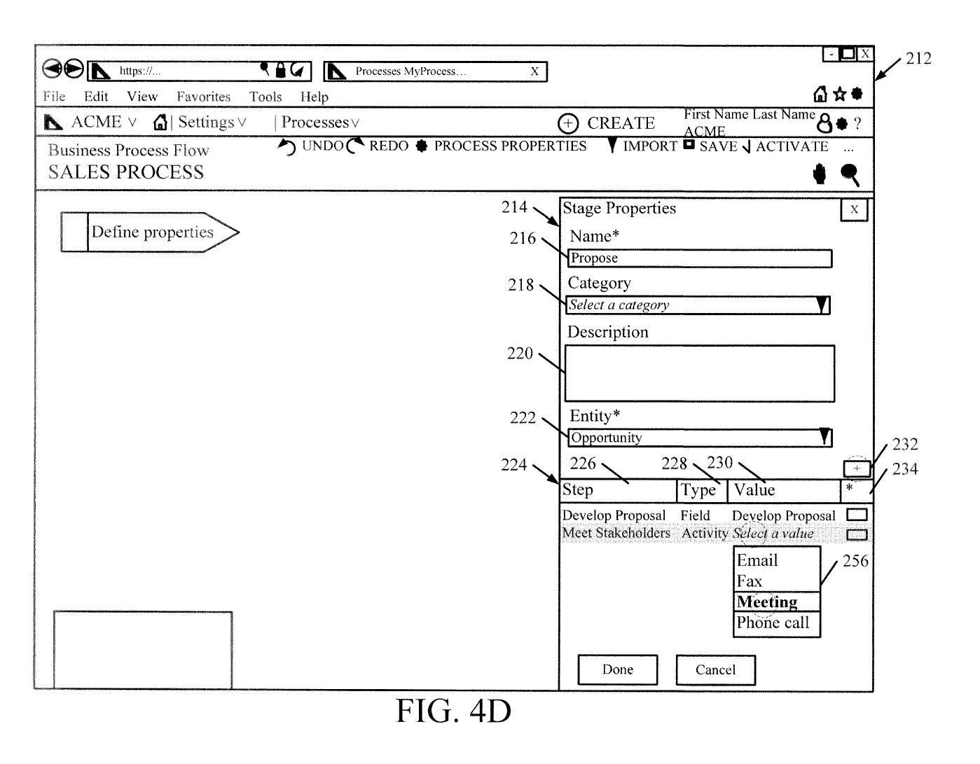

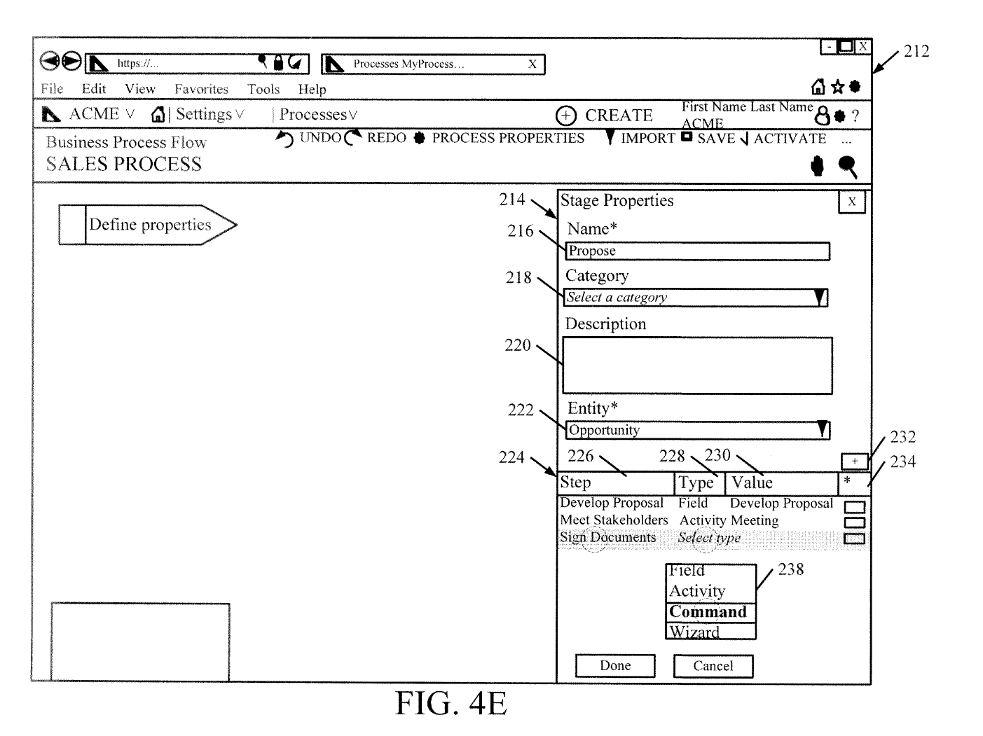

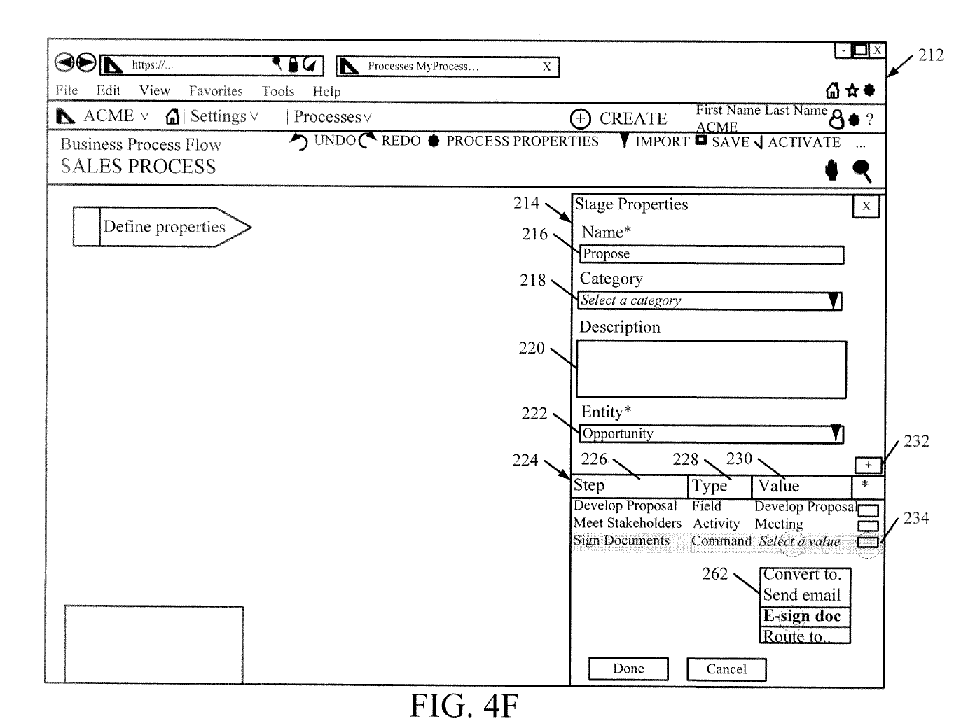

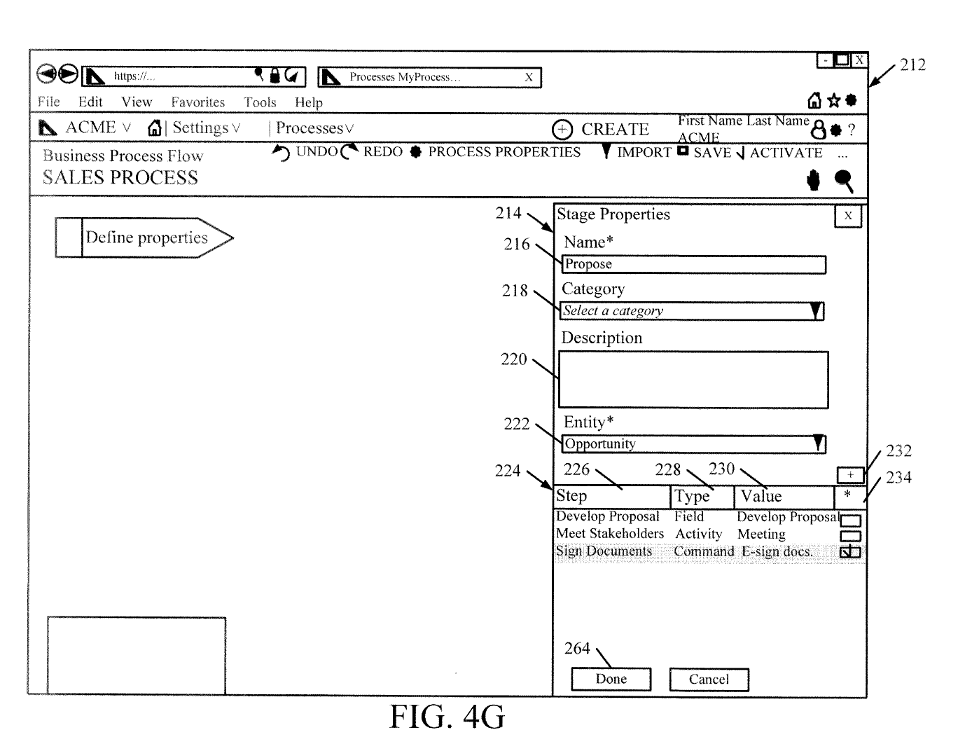

Entity selection component 150 allows a user who is configuring a business process to select an entity that will be the business record that forms the basis for the process, or a given stage within the process. Stage configuration component 152 generates user interface displays with user input mechanisms that allow the user to arrange stages in a given sequence in order to perform the business process. Step configuration component 154 illustratively generates user interface displays with user input mechanisms that allow a user to define individual steps within a given stage. Customer action definition component 158 generates user interface displays with user input mechanisms that allow a user to define a custom action. Action mapping component 158 illustratively maps individual steps, within stages of a business process being configured, to the action functionality 120 that is invoked in order to perform an action corresponding to that step. These items are described in greater detail below with respect to FIGS. 3-4H.

FIGS. 3A and 3B (collectively FIG. 3) show a flow diagram illustrating one example of the operation of business process configuration system 118 in generating user interface displays with user input mechanisms that allow a user to configure a business process. Business system 102 first receives an input from user 108 indicating that the user wishes to access or generate a business process. This is indicated by block 162 in FIG. 3.

Business process configuration system 118 then, either by itself, or using user interface component 114, generates a process configuration user interface display that allows user 108 to configure a business process. This is indicated by block 164. The user interface display illustratively includes user input mechanisms that can be actuated by user 108 in order to arrange stages in a given sequence to define the business process. Within each stage, the user can also illustratively configure a set of steps. In order to do so, user 108 first provides an input selecting a given stage in the business process to be configured. This is indicated by block 166 in FIG. 3.

Stage configuration component 152 then displays user input mechanisms for identifying the selected stage. The user 108 provides user inputs indicative of identifying information used to identify the selected stage, using those user input mechanisms. Displaying the user input mechanisms for identifying a stage is indicated by block 168, and receiving user inputs to identify the stage the indicated by block 170.

It will be appreciated this stage can be identified in a wide variety of different ways. For instance, a user input mechanism can be provided for the user to identify the name 172 of the stage. A user input mechanism can be provided to allow the user to identify the category 174 of the stage and the particular entity 176 which is the business record upon which the stage is based. It also illustratively provides a description user input mechanism 178 that allows the user to enter a description of the stage. It can of course provide other user input mechanisms 180 that allow the user to identify the stage in other ways as well.

Step configuration component 154 also illustratively displays user input mechanisms for defining steps in the selected stage. This is indicated by block 182 in FIG. 3. Receiving user inputs defining the steps is indicated by block 184. Component 154 can display user input mechanisms for defining action steps, and receive user inputs defining action steps. This is indicated by block 183 and 185 in FIG. 3. Some examples of configuring various steps are described in greater detail below with respect to FIGS. 4-4G.

Stage configuration component 152 also illustratively displays user input mechanisms that allow the user to define transitions between the stages. This is indicated by block 186. For instance, the user input mechanisms can allow the user to indicate that certain steps are necessary steps as indicated by block 188. Component 152 can also provide user input mechanisms that allow the user to define branching and gating conditions as transition conditions for transitioning between the stages. This is indicated by block 190. User input mechanisms can be generated to define transitions between the stages in other ways as well, and this is indicated by block 192.

The user then provides user inputs on those user input mechanisms in order to define the transitions. This is indicated by block 194. User 108 can perform other process configuration actions to configure other portions of the process as well. This is indicated by block 196.

Configuration system 118 then generates code for performing the process, as configured by the user. This is indicated by block 198. The code can include metadata 200 for defining the process. It can also illustratively include the mappings between the various steps in the process and action functionality 120. This is indicated by block 202. It can include the business logic code. This is indicated by block 204. It can include generating code in other ways as well, and this is indicated by block 206.

In one example, configuration system 118 can include an editor that automatically generates intermediate code that is then automatically converted by various conversion components into code that can be used by the various mechanisms in user devices that are used to access business system 102. By automatically, it is meant that it is done substantially without any other user involvement or action, except perhaps to enable the functionality. For instance, the code can be converted to code that is understandable by mobile applications that run portions of business system 102. It can be converted into code that is understandable by a web browser, by personal information managers, and/or development components. In another example, the code is generated directly for the various clients, without first generating intermediate code.

By way of one example, the editor can convert the code into XML or a variant thereof. A given conversion component can be included in the business system 102 for each context in which the business system 102 is deployed. Therefore, there can be a conversion component to convert the XML into code understandable by mobile applications. There can also be a conversion component to convert the code into code that is understandable by a web browser, etc.

The configured process is then saved to business data store 112 for later execution in business system 102. This is indicated by block 208 in FIG. 3.

FIG. 4 is a flow diagram illustrating one example of the operation of process configuration system 118 in more detail. FIG. 4 specifically illustrates how individual steps within a stage of a business process can be configured. FIGS. 4A-4G show examples of user interface displays that indicate this as well. FIGS. 4-4G will now be described in conjunction with one another. It will be noted that the dashed circles on the user interface displays indicate user actuation of a display element (such as by touching on a touch sensitive display or clicking using a point and click device).

It is first assumed that user 108 has selected a given stage within a business process, where the steps in that given stage are to be configured. FIG. 4A shows one example of a user interface display 212 that indicates this. It can be seen that user 108 has accessed business process configuration system 118 in order to configure a business process entitled “Sales Process”. In response, stage configuration component 152 has generated a user interface display element 214 that allows user 108 to configure a stage in the identified business process. User interface display element 214 includes a name user input mechanism 216 that allows the user to enter a name for the stage being configured. It includes a category user input mechanism 218 that allows the user to select a category for the stage, and a description user input mechanism 220 that allows the user to enter a description for the stage. Display element 214 also illustratively includes an entity identifier user input mechanism 222 that allows the user to select an entity from within the business system as the entity which forms the basis of the particular stage being configured.

Step configuration component 154 illustratively generates a step configuration user interface display element 224. Display element 224 illustratively includes a step name user input mechanism 226, a step type user input mechanism 228, a step value user input mechanism 230, an add user input mechanism 232 and a gate user input mechanism 234.

User input mechanism 226 allows a user to define a name for a given step within the stage being configured. User input mechanism 228 allows a user to define a type for the step, and value user input mechanism 230 allows the user to define a value for this particular type of step. Add user input mechanism 232 can be actuated to allow the user to add another step in this stage, and gate user input mechanism 234 can be actuated to indicate that a given step is required before traversing from this stage to a subsequent stage in the business process being configured.

It can be seen in FIG. 4A that the user has entered the name “develop proposal” using the name user input mechanism 226. Displaying name user input mechanism 216 and receiving the user input naming the step is indicated by blocks 235 and 236, respectively, in the flow diagram of FIG. 4.

It can also be seen in FIG. 4A that the user has actuated the type user input mechanism 228 so that the system has displayed a type user input mechanism 238 that allows the user to define a type of step that is being configured. Displaying the type user input mechanism is indicated by block 240 in the flow diagram of FIG. 4.

In the example shown in FIG. 4A, user input mechanism 238 is a drop down box that allows the user to select from a plurality of different types for the step being configured. Receiving a user input identifying the step type is indicated by block 242 in the flow diagram of FIG. 4. The different step types can include field steps, action steps, etc. The action steps can, themselves, be of different types, such as commands, launch dialog, create activity, etc. Further, commands may be of different types, such as a ribbon/commands bar commands, a process action command, or triggering (or invoking) a web resource (like a script). In one example, the step types can change based on the user who is interacting with the business process at runtime. This can be configured as well using suitable user input mechanisms. In another example, the process can be configured so that commands are triggered on transitions within the business process or so the commands trigger transitions with the process. Further, the steps can be configured to show state information associated with the steps, such as whether a corresponding command has been executed in the past, whether it was successful, whether any errors occurred, etc. In the example illustrated, several different step types are shown, including a field 246, an activity 248, a command 250, a wizard 252 and another type 254. These are examples only. In the example shown in FIG. 4A, the user is actuating the “field” user input mechanism in drop down box 238.

In response, step configuration component 154 then generates a type-specific user input mechanism for defining a value for the given step type that was just selected. By way of example, FIG. 4B shows that, since the step type is “field”, the user can enter text defining the value for that field. The user has entered “develop proposal” for the field corresponding to this step. FIG. 4B also shows that the user is actuating the add actuator 132 to add another step to this stage.

FIG. 4C shows that the user has entered a step name as “meet stakeholders” for the next step. The user has then actuated the type user input mechanism 228 and the system has again generated drop down menu 238 for selecting a type corresponding to this step. It can be seen in FIG. 4C that the user is actuating the “activity” user input mechanism defining this particular step as an activity.

In response, the system generates another type-specific user input mechanism that allows the user to define a value for the activity. FIG. 4D shows one example of a user interface display indicating this. It can be seen in FIG. 4D that the system has generated a type-specific user input mechanism 256 that allows the user to select a particular type of activity. In the example shown in FIG. 4D, the types of activity that can be selected include “e-mail”, “fax”, “meeting”, or “phone call”, although these are examples only. It can be seen in FIG. 4D that the user is actuating the “meeting” user input mechanism to indicate that the activity for this step is to schedule a meeting. FIG. 4D also shows that the user is again actuating the add actuator 232 to add another step to this stage.

FIG. 4E shows that the user has now assigned a name “sign documents” to the next step in the stage. The user has actuated the “select type” user input mechanism 228 and the system has again displayed drop down box 238. FIG. 4E shows that the user is selecting the “command” type for this particular step in the stage. Thus, FIG. 4F shows that the system has generated another type-specific user input mechanism 262 that allows the user to select a value for the command corresponding to this step. In the example shown in FIG. 4F, the user can select, as a command, a “convert to” command, a “send e-mail” command, a “e-sign document” command, a “route to” command, etc. FIG. 4F also shows that the user is actuating user input mechanism 234 to indicate that this step is required in this particular stage, before the user is allowed to move to another stage during the runtime process.

FIG. 4G shows the configured stage. The stage name is “propose”, the corresponding entity that the stage operates on is an “opportunity” entity, and the stage has three steps “develop proposal”, “meet stakeholders”, and “sign documents”. The user can then illustratively actuate the “done” actuator 264. This causes the system to save this stage in the corresponding business process.

Returning again to the flow diagram of FIG. 4, displaying the type-specific user input mechanism for defining a value for a step type is indicated by block 266. Receiving the user input defining the value for the step type is indicated by block 268. Receiving a user input defining whether the step is a required step for this stage is indicated by block 270. If the user actuates the add user input mechanism 232, this indicates that the user wishes to add more steps and processing thus reverts to block 210. This is indicated by block 272.

Once the user has configured all desired steps for a given stage, processing moves to block 274 where, if not already done, the action mapping component 158 in business process configuration system 118 maps certain steps to the action functionality 120. In one example, steps of different types are already and automatically mapped to the corresponding functionality as the step type is defined. Therefore, a user can take action corresponding to each configured step during the runtime operation of the process. Mapping the steps to the action functionality is indicated by block 274.

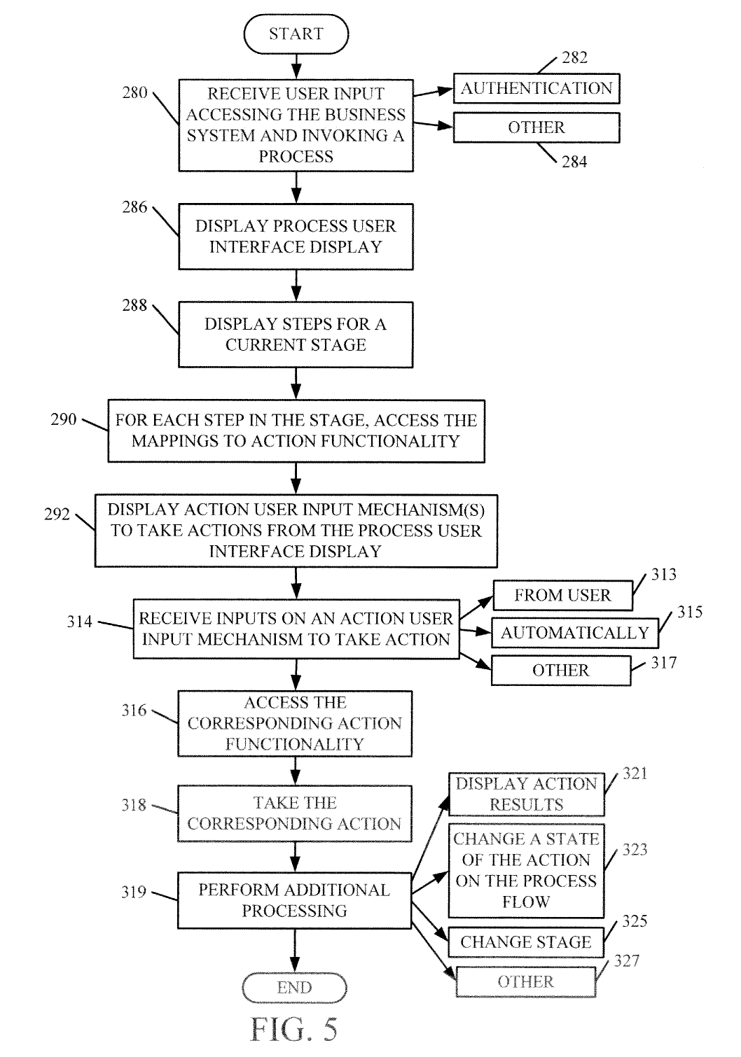

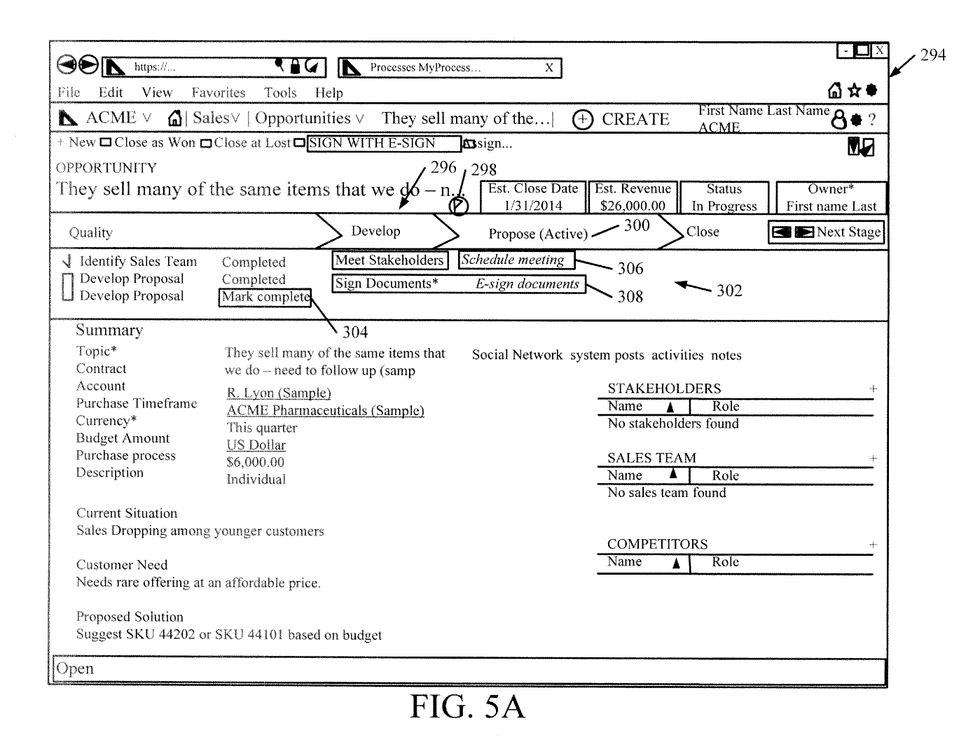

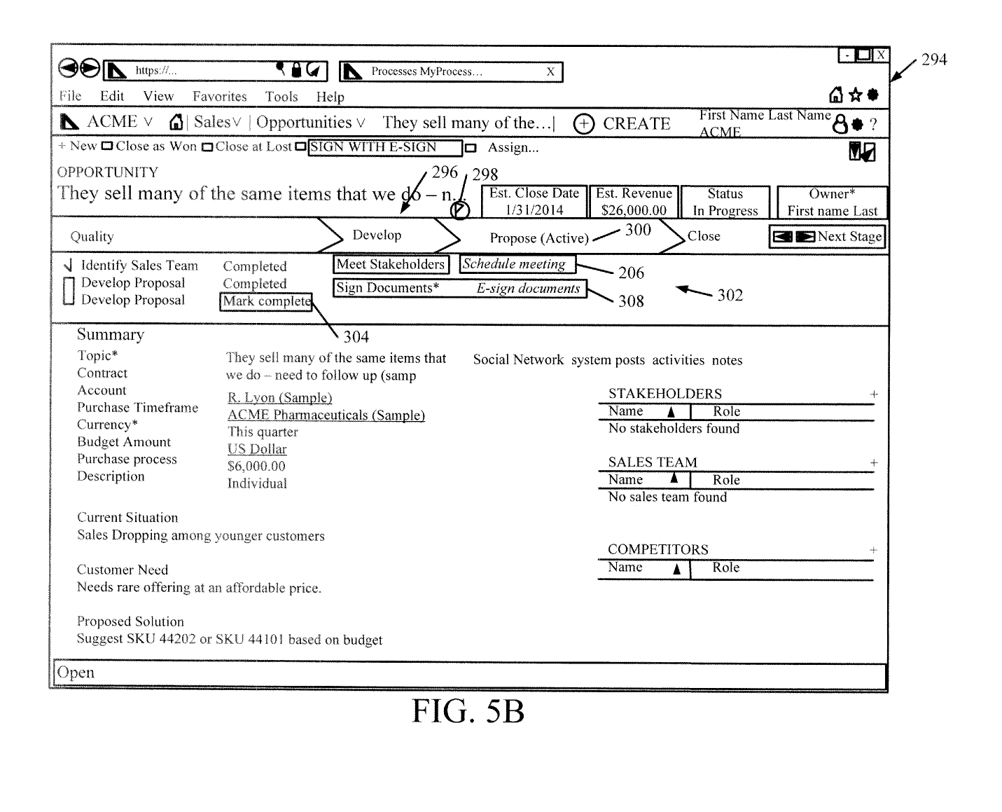

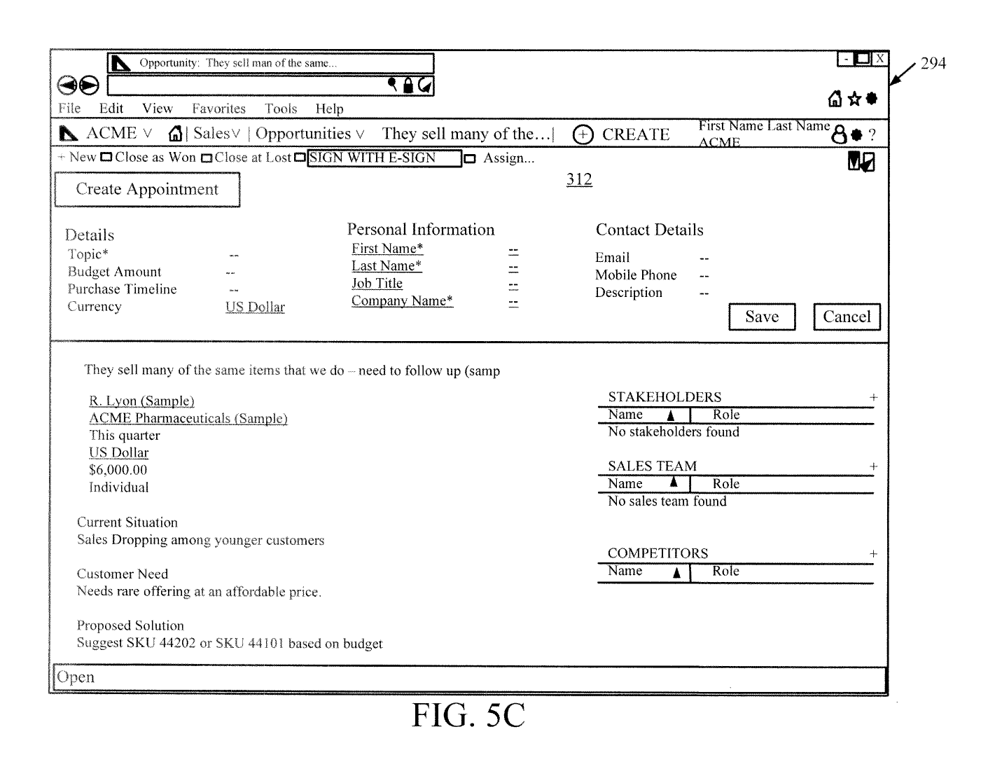

FIG. 5 is a flow diagram illustrating one example of the operation of business system 102, during runtime, in executing a business process. FIGS. 5A-5C show examples of user interface displays. FIGS. 5-5C will now be described in conjunction with one another.

Application component 116 (or another part of business system 102) receives a user input accessing the business system and invoking a business process during runtime. This is indicated by block 280 in FIG. 5. The user can do this, for example, by providing authentication inputs 282, or in other ways 284.

The business system 102 then displays a process user interface display that allows the user to conduct various activities, or tasks, review metrics corresponding to the process or perform other functions in order to carryout the business process. Displaying the process user interface display is indicated by block 286 in FIG. 5.

The user then selects a given stage within the business process in order to perform work. In response, the application component 116 illustratively displays the steps for a selected stage and, for each step in the stage, it accesses the mappings to action functionality that were generated for those steps and displays action user input mechanisms for the steps. User 108 can thus take actions from the process user interface display in order to perform any given step. Displaying the steps for a current stage is indicated by block 288. Accessing the mappings to the action functionality is indicated by block 290 and displaying the action user input mechanisms is indicated by block 292.

The mappings can indicate a variety of different things. For instance, they can represent an actuatable link into a system within action functionality 120. As an example, if the step has sending an email as an action, the mapping may indicate an actuatable link into the email system in functionality 120 so that when the user actuates the link, the user is presented with the user input mechanisms, generated by the email system, for composing and sending an email. The mappings can be similar for other actions as well.

FIG. 5A is a user interface display 294 that illustrates one example of this. It can be seen in FIG. 5A that the user has accessed a sales process corresponding to the “opportunity” entity. The sales process has a plurality of different stages generally displayed using a stage display mechanism 296. The stages include a “qualify” stage, a “develop” stage, a “propose” stage and a “close” stage. The process corresponds to the process that was configured as described above with respect to FIGS. 4-4G.

Each of the stages has an indicator, indicating whether it has been completed. For instance, the “qualify” and “develop” stages have check marks on stage display mechanism 296 indicating that they have been completed. The “propose” stage has a place identifier 298 indicating that the user is at that stage in the process. It also has an active indicator 300 indicating that the stage is currently active. Because the user is at the “propose” stage in the process, a steps display portion 302 displays the various steps that correspond to the “propose” stage.

It can be seen that the steps include a “develop proposal” step, a “meet stakeholders” step and a “sign documents” step as described above with respect to FIGS. 4-4H. Also, as described above, the “develop proposal” step is of the “field” type and therefore a text field 304 is displayed in that step. The “meet stakeholders” step is an “activity” type and the value is “meeting”. Therefore, that step is displayed along with a “schedule meeting” user input mechanism 306 that can be actuated by the user in order to schedule a meeting. The “sign documents” step is a “command” type and therefore it includes user input mechanism 308 that can be actuated by the user in order to execute the associated command which is to electronically sign documents.

As discussed above, each of the user input mechanisms 304, 306 and 308 can be mapped to corresponding action functionality 120. Therefore, for instance, the schedule meeting user input mechanism 306 can be mapped to the scheduling system 138 (or scheduling system 138 is invoked from the process display 294) in action functionality 120. Thus, when the user actuates the schedule meeting user input mechanism 306, the user is automatically navigated to scheduling system 138 where the scheduling functionality is invoked so that the user can schedule a meeting within the context of user interface display 294. Similarly, when the user actuates the e-sign documents user input mechanism 308, the user is navigated to command execution system 140 that generates user interface displays that allow the user to electronically sign an underlying document. Of course, when the user had selected other values for the action types in configuring the “propose” stage, then user input mechanisms would be displayed on the runtime display 294, for those steps, but they would be mapped to other, appropriate, action functionalities so that the user could take those actions directly from the context of user interface display 294 as well.

FIG. 5B shows that the user can actuate the schedule meeting user input mechanism 306 and be navigated to a scheduling experience where the user can schedule a meeting, within the context of user interface display 294. FIG. 5C shows that, in one example, the scheduling system 138 can generate a scheduling pane 312 that allows the user to schedule an appointment or a meeting directly from within the context of user interface display 294. The user, where appropriate, could actuate a user input mechanism to launch a wizard, create and run custom actions, etc.

It should also be noted that the input mechanisms to trigger an action or other field type processing can be input by a user or it can be received automatically. For instance, the mechanisms can be automatically populated with default values or populated or activated based on information from a form, from a script associated with an entity form, etc.

Returning again to the flow diagram of FIG. 5, receiving inputs on an action user input mechanism to take an action is indicated by block 314. Receiving user inputs is indicated by block 314. Receiving automated inputs is indicated by block 315 and receiving other inputs is indicated by block 317. Accessing the corresponding action functionality is indicated by block 316, and taking the corresponding action by invoking that functionality is indicated by block 318.

After taking the action, the system can perform any additional processing as indicated by block 319. This can include displaying results of the action, as indicated by block 321, changing a state of the action as indicated by block 323, transitioning to another stage as indicated by block 325, or other processing as indicated by block 327. As another example, the action results can be mapped back into fields on the form. The results can trigger associated scripts on the form (e.g., using call backs), among other things.

It can thus be seen that configuration system 118 allows a user (an administrator, developer or end user) to configure a step within a stage of a process so that the step is mapped to underlying action functionality, such as executing commands, launching wizards, creating tasks, e-mails, phone calls and appointment records, as well as a whole host of other actions, directly from within the business process flow. This significantly expands and enhances the utility of the business process flow. It can permit out of the box custom commands to be mapped to, and executed from, steps in a stage of the business process flow. The custom actions can be defined through user interface mechanisms so that they can be executed from steps in a stage of the business process flow. It enables mapping and launching of wizards defined through user interface displays, from steps in a stage of the business process flow, and it enables steps in the process flow to map to, and launch, various action experiences so that actions can be taken therefrom. For instance, it can launch a scheduling experience for tasks, phone calls, electronic mail messages, appointments and custom activities. This not only improves the performance of the business process itself, because the user is no longer navigating through various different components of the business system, but it improves the performance of the individual users by surfacing relevant functionality more quickly.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

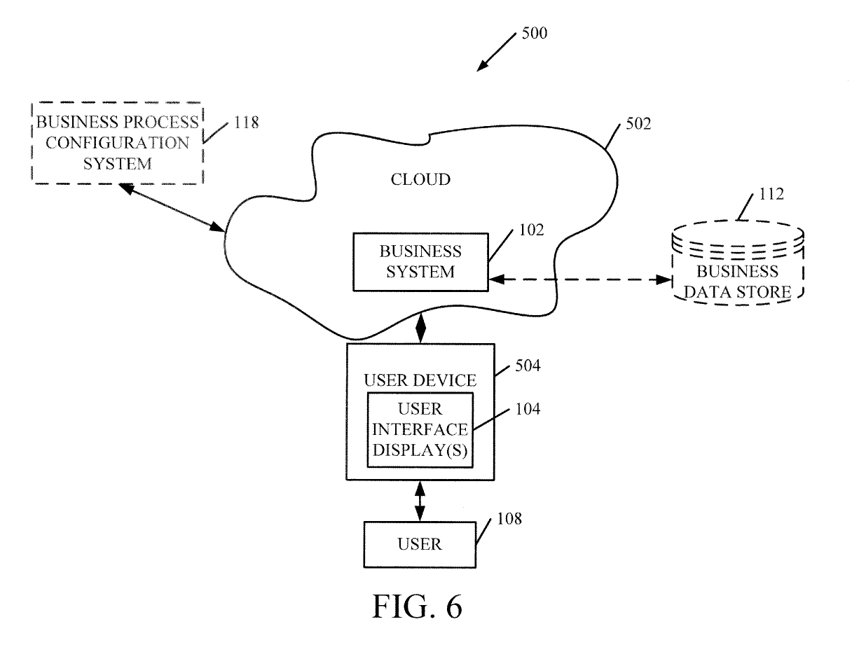

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 1 and they are similarly numbered. FIG. 6 specifically shows that business system 102 can be located in cloud 502 (which can be public, private, or a combination where portions are public while others are private). Therefore, user 108 uses a user device 504 to access those systems through cloud 502.

FIG. 6 also depicts another embodiment of a cloud architecture. FIG. 6 shows that it is also contemplated that some elements of business system 102 can be disposed in cloud 502 while others are not. By way of example, data store 112 can be disposed outside of cloud 502, and accessed through cloud 502. In another embodiment, business process configuration system 118 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

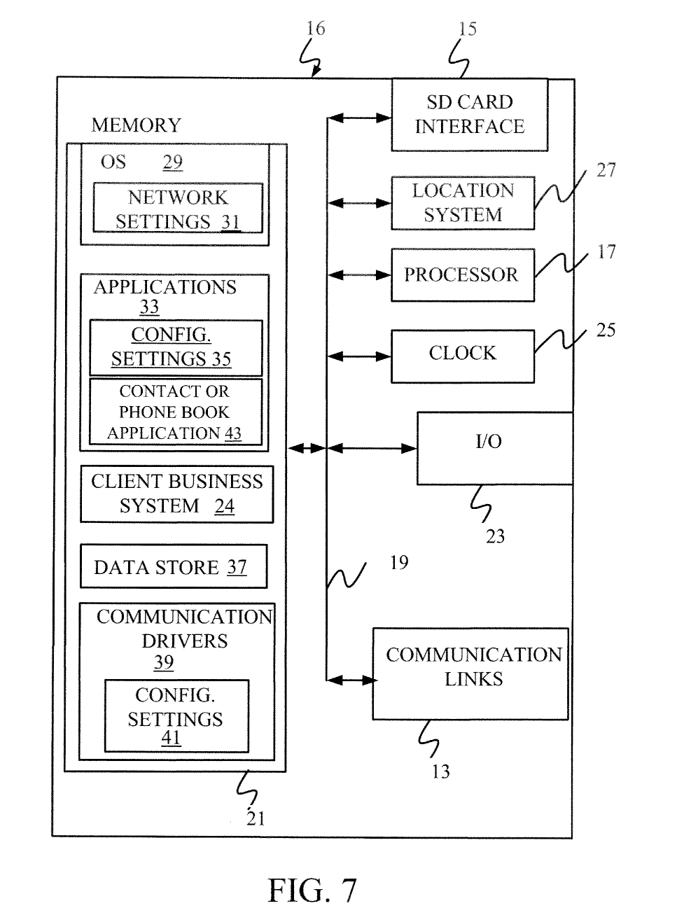

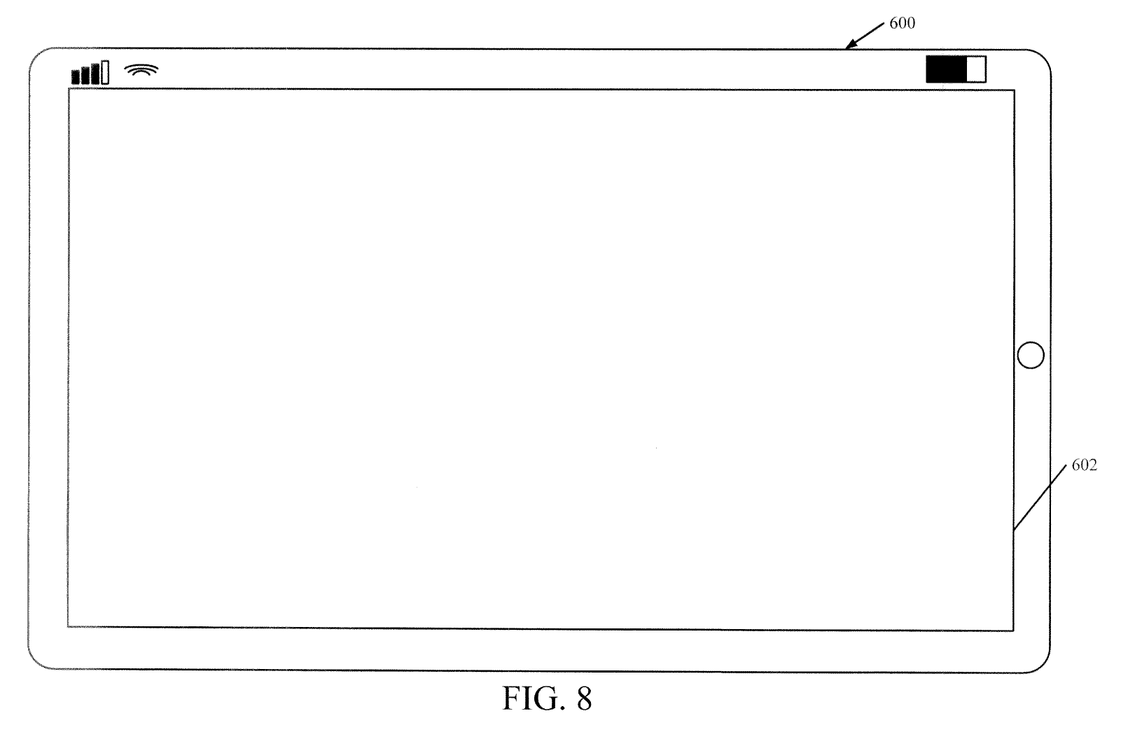

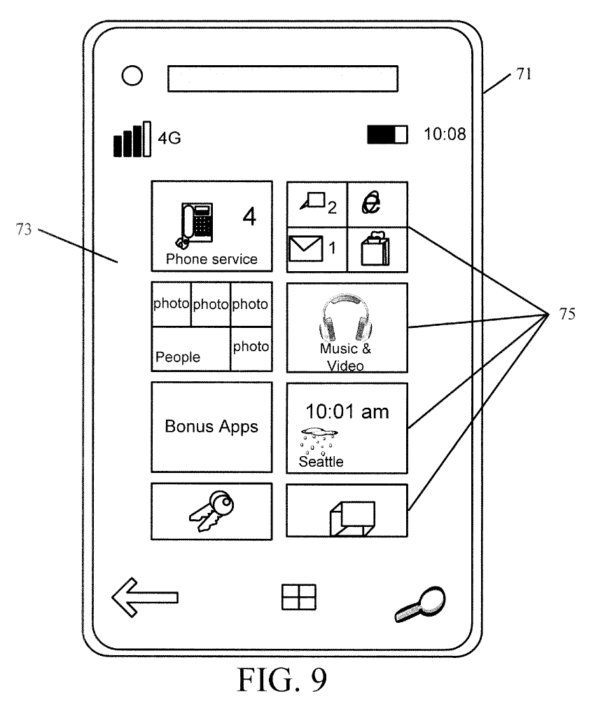

FIG. 7 is a simplified block diagram of one illustrative embodiment of a handheld or mobile computing device that can be used as a user's or client's hand held device 16, in which the present system (or parts of it) can be deployed. FIGS. 8-9 are examples of handheld or mobile devices.

FIG. 7 provides a general block diagram of the components of a client device 16 that can run components of business system 102 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 110 from FIG. 1 or processors in user device 504) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of tenant 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one embodiment in which device 16 is a tablet computer 600. In FIG. 8, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some examples, the phone also includes a Secure Digital (SD) card slot that accepts a SD card.

The mobile device can also be a personal digital assistant (PDA) or a multimedia player or a tablet computing device, etc. (hereinafter referred to as PDA). The PDA includes an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 9 shows an example where the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

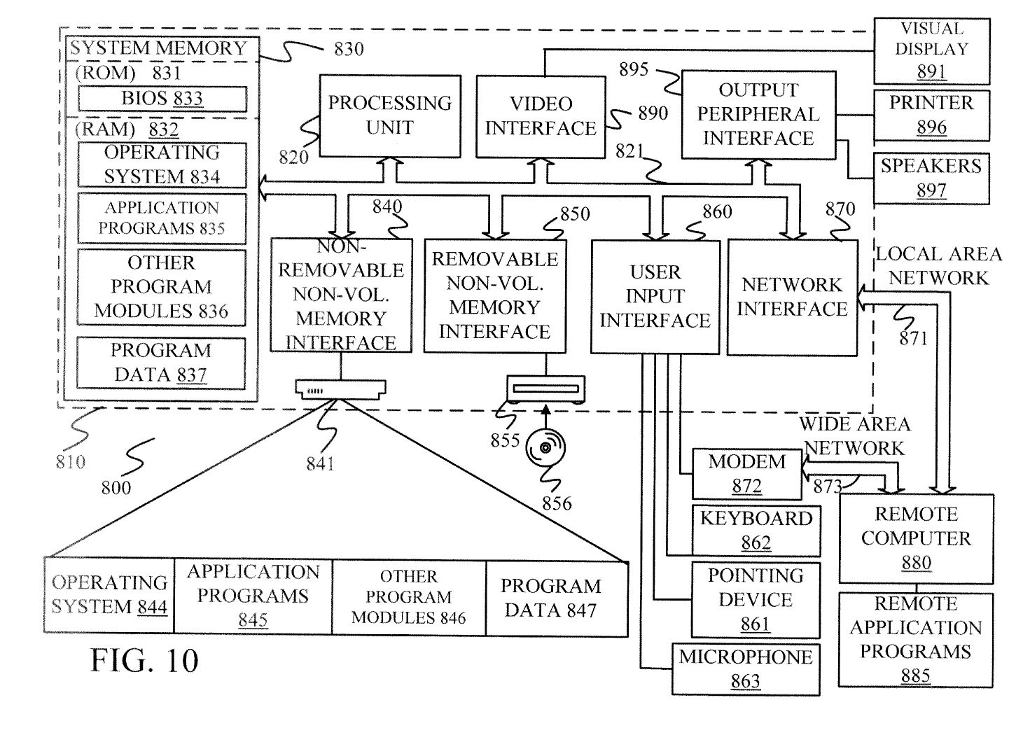

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 110 or processors in user devices 504), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computer system, comprising:

a process configuration system that generates configuration displays with configuration user input mechanisms that are actuated to configure a plurality of steps in the process, the configuration user input mechanisms including action user input mechanisms that are actuated to define an action to be taken in a given step;

action functionality that performs actions in the computer system; and

an action mapping component that maps the given step to the action functionality, based on the defined action, to obtain a mapping that is indicative of a link from a runtime user interface display of the step in the process to action functionality that generates action user input mechanisms to take the defined action based on actuation of the link.

Example 2 is the computer system of any or all previous examples wherein the process comprises a business process with a plurality of different stages, the process configuration system displaying the configuration displays with a stage identifier actuatable to identify a stage for configuration.

Example 3 is the computer system of any or all previous examples wherein the process configuration system generates the configuration displays with a step user interface element, the configuration user input mechanisms including step configuration mechanisms displayed on the step user interface element, actuatable to configure a set of steps for the identified stage.

Example 4 is the computer system of any or all previous examples wherein the process configuration system comprises:

a step configuration component that displays the step configuration mechanisms to include a step type input mechanism actuatable to identify a step type for a corresponding step.

Example 5 is the computer system of any or all previous examples wherein the step type identifies to the step configuration component a type of action to be taken for the corresponding step.

Example 6 is the computer system of any or all previous examples wherein the step configuration component generates a type-specific value input mechanism, based on the identified step type, actuatable to identify an action value for the identified step type.

Example 7 is the computer system of any or all previous examples wherein the step configuration component displays step type input mechanisms corresponding to a set of step types comprising an activity type, a command type and a wizard type.

Example 8 is the computer system of any or all previous examples wherein the step configuration component displays the type-specific value input mechanism, for the activity type, to identify a set of action values comprising communication actions and scheduling actions.

Example 9 is the computer system of any or all previous examples wherein the step configuration component displays the type-specific value input mechanism, for the command type, to identify a set of action values comprising command actions.

Example 10 is the computer system of any or all previous examples wherein the step configuration component displays the type-specific value input mechanism, for the wizard type, to identify a set of action values comprising launching and processing a wizard.

Example 11 is a method, comprising:

receiving a user input accessing a process in a computer system;

displaying a process display, the process display including step display elements, each step display element being indicative of progress in executing a corresponding step in the process, the step display element including an action user input mechanism that is actuatable to perform an associated action, from the process display;

receiving user actuation of a given action user input mechanism on the step display element of the process display; and

taking the action associated with the given action user input mechanism.

Example 12 is the method of any or all previous examples wherein the computer system comprises a business system and wherein receiving a user input accessing a process comprises:

receiving a user input accessing a business process in the business system.

Example 13 is the method of any or all previous examples wherein displaying a process display comprises:

displaying a stage display element that has selectable stage identifiers each identifying a stage to be performed in the process;

receiving selection of a given stage identifier; and

displaying step display elements for steps a stage identified by the given stage identifier.

Example 14 is the method of any or all previous examples wherein taking the action comprises:

accessing a mapping between the given action user input mechanism and an action functionality system that generates user interface displays for taking the action within a context of the process display.

Example 15 is the method of any or all previous examples wherein taking the action comprises:

generating activity user interface displays on the process display for performing an activity.

Example 16 is the method of any or all previous examples wherein taking the action comprises:

generating command user interface displays on the process display for executing a command.

Example 17 is the method of any or all previous examples wherein taking the action comprises:

generating wizard user interface displays on the process display for executing a wizard.

Example 18 is a computer system, comprising:

an application component that runs a process and generates a process user interface display indicative of advancement through the process, the process user interface display including step user interface display elements identifying steps to take to perform the process, a given step user interface display element including a given action user input mechanism corresponding to an action to be taken to perform the given step in the process; and

an action functionality system that, in response to actuation of the given action user input mechanism on the process user interface display, takes the corresponding action.

Example 19 is the computer system of any or all previous examples wherein the process comprises a business process run in a business system, the application component generating the process user interface display with a stage display element comprising a plurality of selectable stage identifiers, each identifying a stage in the business process, the application component receiving user selection of a selectable stage identifier and displaying step user interface elements corresponding to steps in the selected stage.

Example 20 is the computer system of any or all previous examples wherein the action functionality system generates action user input mechanisms for user actuation to take the action from within a context of the process user interface display.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system, comprising:
a process configuration system that generates configuration displays with configuration user input mechanisms that are actuated to configure a plurality of steps in the process, the configuration user input mechanisms including action user input mechanisms that are actuated to define an action to be taken in a given step;
action functionality that performs actions in the computer system; and
an action mapping component that maps the given step to the action functionality, based on the defined action, to obtain a mapping that is indicative of a link from a runtime user interface display of the step in the process to action functionality that generates action user input mechanisms to take the defined action based on actuation of the link.

2. The computer system of claim 1 wherein the process comprises a business process with a plurality of different stages, the process configuration system displaying the configuration displays with a stage identifier actuatable to identify a stage for configuration.

3. The computer system of claim 2 wherein the process configuration system generates the configuration displays with a step user interface element, the configuration user input mechanisms including step configuration mechanisms displayed on the step user interface element, actuatable to configure a set of steps for the identified stage.

4. The computer system of claim 3 wherein the process configuration system comprises:
a step configuration component that displays the step configuration mechanisms to include a step type input mechanism actuatable to identify a step type for a corresponding step.

5. The computer system of claim 4 wherein the step type identifies to the step configuration component a type of action to be taken for the corresponding step.

6. The computer system of claim 5 wherein the step configuration component generates a type-specific value input mechanism, based on the identified step type, actuatable to identify an action value for the identified step type.

7. The computer system of claim 6 wherein the step configuration component displays step type input mechanisms corresponding to a set of step types comprising an activity type, a command type, a wizard type, and a web resource invocation type.

8. The computer system of claim 7 wherein the step configuration component displays the type-specific value input mechanism, for the activity type, to identify a set of action values comprising communication actions and scheduling actions.

9. The computer system of claim 7 wherein the step configuration component displays the type-specific value input mechanism, for the command type, to identify a set of action values comprising command actions.

10. The computer system of claim 7 wherein the step configuration component displays the type-specific value input mechanism, for the wizard type, to identify a set of action values comprising launching and processing a wizard.

11. A method, comprising:
receiving a user input accessing a process in a computer system;
displaying a process display, the process display including step display elements, each step display element being indicative of progress in executing a corresponding step in the process, the step display element including an action user input mechanism that is actuatable to perform an associated action, from the process display;
receiving user actuation of a given action user input mechanism on the step display element of the process display; and
taking the action associated with the given action user input mechanism.

12. The method of claim 11 wherein the computer system comprises a business system and wherein receiving a user input accessing a process comprises:
receiving a user input accessing a business process in the business system.

13. The method of claim 12 wherein displaying a process display comprises:
displaying a stage display element that has selectable stage identifiers each identifying a stage to be performed in the process;
receiving selection of a given stage identifier; and
displaying step display elements for steps a stage identified by the given stage identifier.

14. The method of claim 13 wherein taking the action comprises:
accessing a mapping between the given action user input mechanism and an action functionality system that generates user interface displays for taking the action within a context of the process display.

15. The method of claim 14 wherein taking the action comprises at least one of:
transitioning to a different stage; and
generating activity user interface displays on the process display for performing an activity.

16. The method of claim 14 wherein taking the action comprises at least one of:
generating command user interface displays on the process display for executing a command; and
generating activity user interface displays on the process display for performing an activity.

17. The method of claim 14 wherein taking the action comprises at least one of:
generating wizard user interface displays on the process display for executing a wizard; and
invoking a web resource.

18. The method of claim 11 and further comprising:
receiving a result of the action taken; and
performing additional processing based on the result.

19. A computer system, comprising:
an application component that runs a process and generates a process user interface display indicative of advancement through the process, the process user interface display including step user interface display elements identifying steps to take to perform the process, a given step user interface display element including a given action user input mechanism corresponding to an action to be taken to perform the given step in the process; and
an action functionality system that, in response to actuation of the given action user input mechanism on the process user interface display, takes the corresponding action.

20. The computer system of claim 19 wherein the process comprises a business process run in a business system, the application component generating the process user interface display with a stage display element comprising a plurality of selectable stage identifiers, each identifying a stage in the business process, the application component receiving user selection of a selectable stage identifier and displaying step user interface elements corresponding to steps in the selected stage.
